(19) United States
(12) Patent Application Publication
(10) Pub. No.: US 2005/0271783 A1
(43) Pub. Date: Dec. 8, 2005

(54) PLANK COOKING DEVICES AND METHODS

(75) Inventor: Randolph E. Digges III., North Olmsted, OH (US)

Correspondence Address: RANKIN, HILL, PORTER & CLARK, LLP, 925 EUCLID AVENUE, SUITE 700, CLEVELAND, OH, 44115-1405, US

(73) Assignee: CLEAR FORK CREEK LLC, Cleveland, OH (US)

(21) Appl. No.: 10/908,282

(22) Filed: May 5, 2005

Related U.S. Application Data
(60) Provisional application No. 60/572,383, filed on May 19, 2004.

(51) Int. Cl. A23L 1/00

(52) U.S. Cl. 426/523; 426/113; 426/132; 426/324

(57) ABSTRACT

The present invention provides a fluid tight package containing one or more wooden cooking planks that have absorbed a hydrating liquid. A wooden cooking plank can be removed from the fluid tight package and used to prepare smoked foods in combination with a plank-cooking pan. The plank-cooking pan protects the wooden plank from igniting or charring, and can be used as a serving platter.

### BACKGROUND OF THE INVENTION

1. Field of Invention

The present invention relates to plank cooking devices and methods of making and using the same.

2. Description of Related Art

Plank cooking is an increasingly popular technique for preparing smoked foods. The origin of the technique is generally attributed to Native American Indian tribes of the Pacific Northwest, who are believed to have used strips of bark and pieces of wood to keep food from falling into open cooking fires during preparation.

In modern plank cooking, food is typically placed on a top surface of a wooden plank that is positioned over or adjacent to a heat source such as the burners of an outdoor barbecue grill or the hot coals of a cooking fire. Heat rising from the heat source causes a bottom surface of the wooden plank to char, generating smoke that contacts the food cooking on the top surface of the wooden plank. The smoke gives the food a distinctive flavor and appearance. Some of the heat is transferred through the wooden plank to the food positioned on the top surface thereof, but the plank is thick enough that it does not burn through, thereby protecting the food from direct exposure to the heat source, which prevents burning and reduces moisture loss. Wood species that release flavorful smoke such as, for example, western redcedar, alder, apple, cherry, maple, pecan, hickory and mesquite, are particularly suitable for use in plank cooking.

Several companies sell precut planks of kiln-dried woods such as western redcedar and alder specifically for plank cooking. The dimensions length and width dimensions of commercially available precut wooden planks vary significantly from supplier to supplier. The thickness dimension is usually greater than 1/2 inch (12.5 mm). Wooden cooking planks can also be cut from untreated kiln-dried wood obtained from a lumberyard.

Most suppliers of precut wooden cooking planks recommend soaking or submerging the kiln-dried planks in water for about two to twenty-four hours prior to use. Although most species of wood will not absorb much water in that period of time, the small amount of water that is absorbed helps the wood release flavorful smoke and also helps prevent the wood from catching fire during cooking. Wood that has not been soaked in a hydrating liquid prior to use tends to burn more rapidly and produce less flavoring smoke than wood that has been soaked in a hydrating liquid for an extended period of time.

Soaking one or more wooden planks prior to use is time consuming and can be somewhat difficult to do. The wooden planks are awkwardly sized, and it is often difficult to find a suitable container for soaking the plank. A container that is significantly larger than the plank requires the use of a substantially large volume of liquid in order to cover the plank. The lack of suitable containers can make it expensive to use some hydrating liquids such as fruit juices. Furthermore, most species of wood tend to float in hydrating liquids, which makes it difficult to submerge the wood in order that all sides or surfaces are adequately hydrated prior to use. This requires that the planks be flipped over periodically to ensure that all surfaces of the wood are exposed to the hydrating liquid prior to use. Some suppliers of precut wooden grilling planks recommend soaking one or more planks in a kitchen sink. This can tie up the sink for long periods of time and make preparation of other menu items difficult.

In view of the foregoing, it will be appreciated that plank cooking presently requires substantial planning and preparation. One must find or create a suitable container for soaking the wooden plank, and must begin doing so many hours in advance of actually grilling the food. The requirements for planning and prior preparation make it very unlikely that one will choose to plank grill a food item on the spur of the moment.

Another problem with modern plank cooking is that it requires the use of a relatively thick plank that can typically be used only one time. If the plank is too thin, the plank may burn through during cooking, which can expose the food on the top surface thereof to burning or charring. Once a plank has been used to prepare food, the bottom surface is severely blackened and charred. While it is sometimes possible to rehydrate a once-used cooking plank for reuse, it is generally not recommended. The charred surface of the once-used plank makes the rehydration process quite messy, and reused cooking planks sometimes impart an undesirable burnt aftertaste to foods. Thus, in conventional plank cooking, a relatively thick plank of wood is used one time and then discarded.

### BRIEF SUMMARY OF THE INVENTION

The present invention provides plank cooking devices and methods of making and using the same. Wooden planks according to the present invention are preferably treated to absorb a hydrating liquid and then sealed within a fluid tight package for future use. Wooden planks according to the invention thus do not need to be soaked in a hydrating liquid for many hours prior to being used for plank cooking. The planks can simply be removed from the fluid tight package and positioned over or adjacent to a heat source and used to prepare a food item. Wooden cooking planks according to the invention can be stored for extended periods of time before use without the need for refrigeration.

In another embodiment of the invention, the wooden cooking planks are used to prepare smoked foods in combination with a plank-cooking pan. In one method of the invention, a sacrificial plank of hydrated wood is preferably placed over or adjacent to a heat source and then covered with the plank-cooking pan. A protected plank of hydrated wood is placed on a top surface of the plank-cooking pan. A food item to be cooked is placed on a top surface of the protected plank of wood either before or after the protected plank of wood has been positioned on the plank-cooking pan. The sacrificial plank of hydrated wood chars and creates smoke that curls around and through openings in the plank-cooking pan to contact and flavor the food placed on the protected plank of hydrated wood. The plank-cooking pan protects the protected plank of humidified wood from igniting or severely charring, but transfers heat through the protected plank and allows it to transfer flavor to the food item placed thereon. Once the food is sufficiently cooked, the plank-cooking pan can be removed from the heat source using a plank-cooking pan lifting tool, and can be used as a serving platter.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### BRIEF DESCRIPTION OF THE DRAWINGS

FIG. 1 is a perspective view of a wooden cooking plank according to the invention.

FIG. 2 is a side view of a plurality of wooden cooking planks according to the invention sealed in a fluid tight package.

FIG. 3 is a perspective view of a plank-cooking pan and a lifting tool according to the invention.

FIG. 4 is a side sectional view of the plank-cooking pan shown in FIG. 3 taken along the line 4-4 with the lifting tool engaged with the plank-cooking pan.

FIG. 5 is a perspective view of an outdoor barbecue grill being used to cook a food item in accordance with a method of the invention.

### DETAILED DESCRIPTION OF THE INVENTION

The present invention provides a product that is useful in plank cooking. The product comprises a fluid tight package within which has been sealed a wooden plank that has absorbed a hydrating liquid. Throughout the instant specification and in the appended claims, the term “hydrating liquid” refers to a water-containing solution, suspension or emulsion that has been intentionally contacted with the wood used to form the wooden plank after the tree from which such wood was obtained has been cut down and is no longer growing. The term “hydrating liquid” does not refer to any water-containing solutions, suspensions or emulsions that may naturally be present in the wood at the time the tree from which such wood was obtained was cut down.

Preferably, the wooden plank has been treated to absorb an amount of a hydrating liquid that is greater than would have been absorbed by the wooden plank had the wooden plank been submerged in an open container of 70° F. (21.1° C.) water at atmospheric pressure for a period of twenty four hours at a depth of three inches (76.2 mm) as measured from the surface of the water to the top surface of the wooden plank. Absorption of the hydrating liquid can be accomplished by a variety of means, and can occur before and/or after the wooden plank has been sealed in the fluid tight package.

FIG. 1 is a perspective view of an exemplary wooden plank 10 having a top surface 20 and a bottom surface 30. Wooden planks 10 can be formed of virtually any variety of wood. Preferred woods include western redcedar, alder, apple, cherry, hickory, pecan and mesquite, each of which produces distinctive flavorful smoke when placed over a heat source. Western redcedar is particularly preferred because it produces smoke that is very pleasant and flavorful. Furthermore, western redcedar is relatively abundant.

The top surface 20 of the wooden plank 10 is a food contacting and supporting surface. The bottom surface 30 of the wooden plank is, at least in some embodiments of the invention, a smoke-generating surface (e.g., via charring or burning). It will be appreciated that the top surface 20 of the wooden plank 10 can be provided with decoration such as by wood burning or branding. The top surface 20 can also optionally be provided with a basin 40 for receiving a food item. The basin 40 is a dished out area that can be formed by carving or cutting the top surface 20 of the wood using any conventional wood working method. A basin 40 advantageously serves as a well for collecting liquids that may drip out of the food item during cooking or that may be applied to the food item before or during cooking. The basin 40 keeps the food item in contact with such liquids and also prevents such liquids from flowing off the top surface 20 of the wooden plank 10 and onto the heat source during cooking.

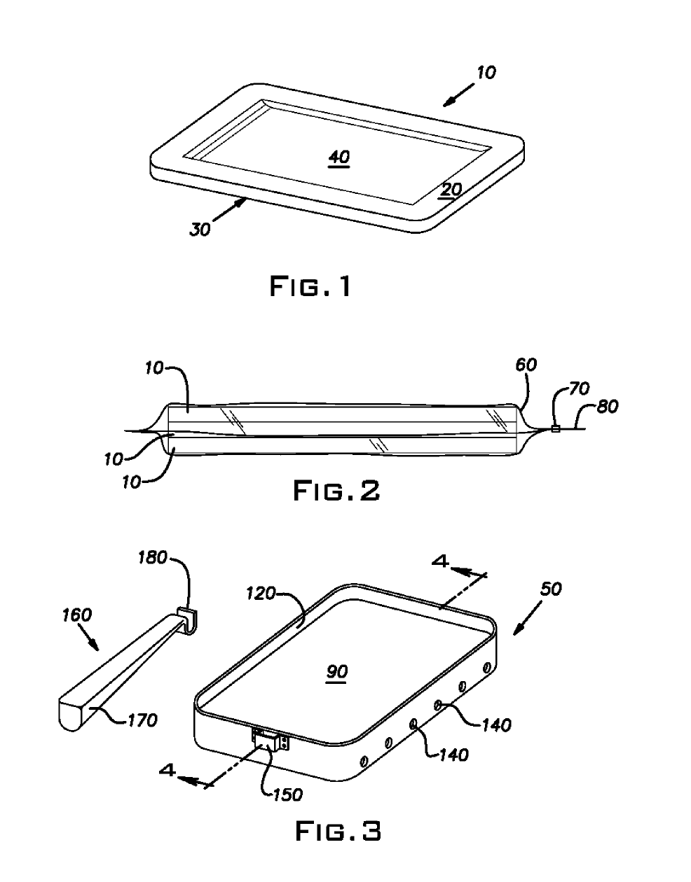

Wooden planks according to the present invention can be of any desired dimension. Wooden planks measuring from about 8 inches (20.3 cm) to about 18 inches (45.7 cm) in length and about 3 1/2 inches (8.9 cm) to about 10 inches (25.4 cm) in width are convenient for many food items. Wooden planks measuring about 10-12 inches (25.4-30.5 cm) in length and 5-6 inches (12.7-15.2 cm) in width are particularly preferred. The thickness dimension of the wooden planks will depend, in part, upon whether a plank-cooking pan 50 (see FIGS. 3-4) is employed. Wooden planks that are used with a plank-cooking pan 50 can be as thin as about 1/8 inch (3 mm) thick, but are preferably about 1/4 inch (6 mm) to about 3/8 inch (9.5 mm) thick. Wooden planks that are used without a plank-cooking pan 50 need to be thicker, typically from about 3/8 inch (9.5 mm) to about 3/4 inch (19 mm) thick.

In accordance with the invention, one or a plurality of wooden planks 10 are sealed in a fluid tight package 60, such as shown in FIG. 2. The fluid tight package 60 is preferably formed from a transparent or translucent polymeric film, but could alternatively be formed from an opaque metal foil. Combinations of metal and polymeric films can also be used. The use of substantially transparent polymeric films allows the aesthetically pleasing wooden plank 10 to be observed by consumers. The fluid tight package 60 ensures that no contaminants contact the wooden plank 10 prior to use, and also prohibits evaporation of the hydrating liquid absorbed in the wooden plank 10 during extended storage. Preferably, the fluid tight package 60 is a vacuum-sealed polymeric film container such as is sometimes used to package meats, cheeses and other perishable food items. The fluid tight package 60 may optionally be provided with a slideable resealing mechanism 70 such as found on ZIPLOCK bags. The fluid tight package 60 may include a removable portion 80, which can be removed by the consumer to expose the resealing mechanism 70.

The wooden plank 10 is preferably treated to absorb a hydrating liquid before being sealed in the fluid tight package 60. As previously noted, the hydrating liquid can be water or virtually any water-containing solution, suspension or emulsion. Hydrating liquids that add desirable flavors to food items that are cooked on the wooden plank are particularly preferred. Preferred hydrating liquids include, for example, fruit juices and extracts, vegetable juices and extracts, beer, wine, liquor, vinegar and combinations of thereof. Apple juice is an excellent hydrating liquid for use with wooden planks cut from western redcedar. The use of alcohol and/or oil-containing hydrating liquids is best absorbed into wooden planks 10 that are to be used to cook foods in combination with a plank-cooking pan 50, which includes a sheet portion that protects the wooden planks from catching fire. Liquor and oil-containing hydrating liquids, while advantageously providing exceptional flavoring, also tend to increase the rate at which the wooden planks ignite if not adequately protected from direct exposure to the heat source.

A residual portion of hydrating liquid can also be sealed in the fluid tight package 60 with the wooden plank 10. Throughout the instant specification and in the appended claims, the term “residual portion” means that at the time the wooden plank was sealed in the fluid tight package, an additional amount of hydrating liquid that had not been absorbed by the wooden plank was also sealed in the package with the wooden plank. If desired, the residual portion of the hydrating liquid can be sealed in the fluid tight package in a frozen state, and can then be permitted to melt. It will be appreciated that the residual portion of the hydrating liquid can, but need not be, absorbed by the wooden plank after the wooden plank is sealed in the fluid tight package. The presence of a residual portion of hydrating liquid in the fluid tight package can make the wooden plank more aesthetically pleasing when the wooden plank is sealed in a transparent vacuum-sealed polymeric (thermoplastic) container.

One or more chemical agents can also be sealed within the fluid tight package (e.g., by virtue of being absorbed into the wooden plank together with the hydrating liquid or applied to the wooden plank before being sealed within the fluid tight package) to inhibit or retard the growth of bacteria and/or mold within the fluid tight package during storage. Preferably, the amount of chemical agent used is sufficient to retard the growth of bacteria and/or mold for more than 180 days without any refrigeration, and more preferably, for an indefinite period of time. Benzoic acid and precursors thereof such as sodium benzoate are particularly suitable for this purpose. Benzoic acid exhibits antimicrobial properties, and it is found naturally in cranberries, prunes, greengage plums, cinnamon, ripe cloves and apples. Sodium benzoate, which is the sodium salt of benzoic acid, is a preferred precursor of benzoic acid and is preferably used in place of benzoic acid because it exhibits greater solubility in water. Sorbic acid and/or precursors thereof such as potassium sorbate can also be used for this purpose. Potassium sorbate is believed to be the most widely used food preservative in the world. Potassium sorbate is effective against yeasts, molds, and select bacteria, and is widely used at 0.025 to 0.10 weight percent levels in a variety of foods. If desired, sorbate and benzoate can be used together to provide greater protection against a wider variety of microorganisms.

Irradiation is another potential alternative to the use of chemical preservatives. A gamma radiation source such as Cobalt 60 can be used to irradiate the packaged wooden planks and thereby kill bacteria and/or microorganisms that may be present therein without harming the flavor of the wood or the hydrating liquid.

Another method of inhibiting the growth of bacteria and/or fungus is to heat sterilize the wooden planks. This can be accomplished via conventional pasteurization or ultra-pasteurization processes, which are known in the art. Pasteurization and ultra-pasteurization, while effective, are less desirable in some instances because they can adversely affect the flavor provided by the hydrating liquid and/or can cause the wooden plank to take on a darkened, dull visual appearance. However, the appearance of the wooden plank can be improved by sealing the wooden plank with a residual portion of hydrating liquid.

In a preferred embodiment of the invention, the wooden plank is pressure treated prior to being sealed in the fluid tight package. Pressure treatment advantageously increases the amount of hydrating liquid that can be absorbed by the wooden plank in a given period of time. The hydrating liquid absorbed by the wooden plank increases the length of time the wooden plank will produce flavoring smoke when positioned over a heat source and further increases the time the wooden plank will survive when exposed to high temperature. Furthermore, it facilitates the use of wooden planks that are thinner than would otherwise be possible.

Pressure treatment can be accomplished in a number of ways. For example, the wooden planks can be forced to the bottom of a tall column of hydrating liquid. A column of water 35 feet (10.7 m) high produces a pressure of about 15 psi (1034 mBar). Pressure treatment can also be accomplished using heat and pressure in a sealed vessel, such as can be produced using a pressure cooker, or using pressure without heat in a sealed vessel, such as can be produced using an autoclave.

In the large-scale practice of the invention, it is contemplated that a large number of precut wooden grilling planks could be placed in an autoclave with minimal physical contact between each plank. A hydrating liquid would be injected into the interior of the autoclave so as to fully contact the exterior surfaces of each piece of wood therein. The pressure in the autoclave would then be increased above atmospheric pressure (e.g., 29-140 psi; 2000-9650 mBar). The temperature within the autoclave would preferably be maintained at or near ambient (˜70° F.; 21.1° C.) for a period of time up to about 30 minutes. Such application of pressure would cause the hydrating liquid to penetrate deep into the pores, cavities, and other exposed interstices on the surfaces of the wooden planks. Alternatively, the temperature in the autoclave could be raised up to about 285° F. (140.5° C.) for a brief period of time. Use of an elevated temperature would also kill any bacteria that may be present in the wood or hydrating liquid, but could also adversely affect the appearance of the wood and the flavor of the smoke. It will be appreciated that the pressures and periods of time for pressurization could vary depending upon the amount of absorption desired. At the end of the specified time at pressure, pressure in the autoclave would be returned to ambient and the wooden planks would be removed and individually vacuum-sealed in fluid tight packages with or without an additional amount of a hydrating liquid.

Spices and other non-liquid seasonings and flavorings can also be sealed within the fluid tight package 60 with the wooden plank(s) 10. Spices such as cloves, mint, garlic, rosemary and pepper can be included to add distinctive flavors to food items prepared on the wooden planks.

As noted above, wooden planks according to the invention are preferably used in combination with a plank-cooking pan 50. However, they can also be used alone. In such instances, the wooden planks 10 are removed from the fluid tight package 60 and promptly used to cook one or more food items in the same manner as conventional wooden planks that have been soaked in a hydrating liquid for many hours immediately prior to use. Specifically, a wooden plank 10 is removed from the fluid tight package 60 and optionally rinsed with cold water. The wooden plank 10 is then placed over or adjacent to a heat source such as the burners of an outdoor barbecue grill. A food item is placed on the top surface 20 of the wooden plank 10 either before or after the wooden plank 10 has been placed over or adjacent to the heat source. The bottom surface of the wooden plank 10 will soon begin to char and produce flavoring smoke. Heat is transmitted through the wooden plank 10 to the food item, but the wooden plank 10 protects the food item from direct exposure the heat source thereby preventing burning and charring of the food item. Preferably, the heat source is the selectively operable burner of an outdoor barbecue grill equipped with a hood that when lowered creates a relatively closed environment that traps heat and smoke. Once the food item has been sufficiently cooked, it can be removed from the wooden plank using tongs and served. If the heat source is an open cooking fire, the wooden plank can simply be added to and consumed by the fire. If the heat source can be turned off (e.g., the heat source consists of selectively operable burners of an outdoor barbecue grill), then the wooden plank will usually stop smoking and cool down to ambient temperature relatively soon after the heat source is turned off. When the wooden plank is completely cool to the touch, it can be rinsed with cold water and discarded.

Wooden planks according to the invention are primarily intended for use in outdoor cooking environments. However, they can be used indoors in baking ovens provided the temperature of the oven is not so high that the wooden plank will ignite or produce copious amounts of smoke. The wooden planks will transmit some wood flavoring to the food, but will generally not produce the smoky flavoring that can be obtained in an outdoor cooking environment.

Although wooden planks according to the invention can be used alone as described above, it is preferable to use the wooden planks 10 in combination with a plank-cooking pan 50 according to the invention. With reference to FIGS. 3 and 4, a plank-cooking pan 50 comprises a sheet portion 90 having a top surface 100 and a bottom surface 110. The sheet portion 90 is preferably formed of a non-combustible material such as stainless steel, cast iron or ceramic that has sufficient rigidity to support a protected wooden plank placed on the top surface of the plank-cooking pan 50 and to facilitate removal of the plank-cooking pan 50 and the protected wooden plank via a lifting operation after the food item has been cooked on the top surface of the protected wooden plank. Stainless steel is the presently most preferred material for use in forming the sheet portion 90 because it is rigid, strong, transfers heat efficiently and is easy to clean. The sheet portion 90 is preferably wider (e.g., at least about 1/2 inch; 12.7 mm) than the width dimension of the sacrificial wooden plank that is covered by the plank-cooking pan 50.

Throughout the instant specification and in the appended claims, the term “sacrificial” wooden plank refers a wooden plank 10 that is positioned above or adjacent to a heat source and is allowed to char and perhaps ignite to produce flavoring smoke. A “protected” wooden plank refers a wooden plank 10 that is supported by the top surface 100 of the sheet portion 90 of the plank-cooking pan 50 and on which is placed a food item to be cooked. A “protected” wooden plank is protected from direct exposure to the heat source by the intermediate sheet portion 90 of the plank-cooking pan 50, and thus is less likely to char or ignite during the preparation of a food item.

The plank-cooking pan 50 preferably further comprises a top wall portion 120 that extends upwardly from a perimeter edge of the sheet portion 90 preferably, but not necessarily, at a right angle relative to a plane defined by the top surface of the sheet portion. The top wall portion 120 is preferably at least as high as the thickness dimension of a protected wooden plank that is to be placed on the top surface 100 of the cooking pan 50. The plank-cooking pan 50 is preferably configured such that an inner side of the top wall portion 120 is spaced relatively close to (e.g., less than 1/4 inch or 6.5 mm), but not in direct contact with, the edges of the protected wooden plank when the bottom surface of the protected wooden plank is in contact with and supported by the top surface 100 of the sheet portion 90 of the plank-cooking pan 50.

Optionally, the plank-cooking pan 50 further comprises a bottom wall portion 130 that either extends downwardly from the perimeter edge of the sheet portion 90 or extends downwardly from the top wall portion 120 preferably, but not necessarily, at a right angle relative to the plane defined by the bottom surface of the sheet portion. The height of the bottom wall portion 130 (i.e., the distance from the bottom surface of the sheet portion of the plank-cooking pan to the bottom of the bottom wall portion) can be greater than or less than a thickness dimension of a sacrificial wooden plank that is to be covered by the plank-cooking pan 50. The plank-cooking pan 50 is preferably configured such that an inner side of the bottom wall portion 130 is spaced at least 1/4 inch (6.5 mm) away from the edges of the sacrificial wooden plank when the plank-cooking pan 50 is covering the sacrificial wooden plank.

When the plank-cooking pan 50 includes a bottom wall portion 130, it is preferable that a plurality of openings 140 be provided through the bottom wall portion 130 to allow for the escape of smoke generated when the sacrificial wooden plank covered by the plank-cooking pan 50 ignites and/or chars during cooking. It will be appreciated that the entire plank-cooking pan 50 can be formed of a single casting, by stamping, or can be formed by joining individual components by welding, using fasteners or by other means.

The plank-cooking pan 50 also preferably further comprises a lifting bracket 150 that is fastened to an outer side of the top wall portion 120. A lifting tool 160 having a handle portion 170 and a hook portion 180 can be used to lift the plank-cooking pan 50 from the heat source via the lifting bracket 150. The hook portion 180 of the lifting tool 160 is configured to slide upwardly into a space between the lifting bracket 150 and the outer side of the top wall portion 120. Once the hook portion 180 has been fully received in the space between the lifting bracket 150 and the outer side of the top wall portion 120, the lifting tool 160 can be used to lift the plank-cooking pan 50 from the heat source, leaving any sacrificial wooden plank that may have been covered by the plank-cooking pan behind. The plank-cooking pan 50 can thus be used as a serving tray, if desired.

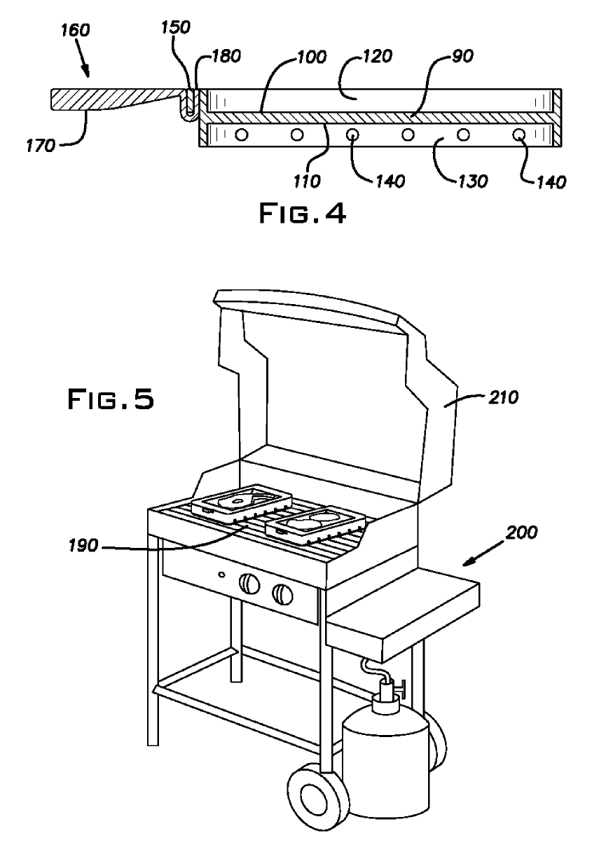

With reference to FIG. 5, to prepare a food item using a plank-cooking pan in accordance with the method of the invention, a first wooden plank (i.e., a sacrificial wooden plank) is placed on a cook top 190 of a heated outdoor barbecue grill 200 or over or adjacent to any other suitable heat source. A plank-cooking pan is then placed on top of the sacrificial wooden plank to cover it. The bottom surface of the sheet portion of the plank-cooking pan can, but need not, contact the top surface of the sacrificial wooden plank. A second wooden plank (i.e., a protected wooden plank) is removed from a fluid tight package and positioned on the top surface of the sheet portion of the plank-cooking pan. A food item to be cooked is then placed on the top surface of the protected wooden plank either before or after the protected wooden plank has been placed on the top surface of the sheet portion of the plank-cooking pan. If possible, the hood 210 of the barbecue grill 200 is preferably lowered to create a substantially closed space for collecting and concentrating the smoke generated when the sacrificial wooden plank chars. The hood also traps heat, which helps accelerate cooking of the food item. Heat rising from the heat sources within the barbecue grill 200 will cause the sacrificial wooden plank to char, and perhaps ignite, creating copious amounts of flavoring smoke. The smoke can escape through the openings in the bottom wall of the plank-cooking pan and fill the hood 210 of the barbecue grill. The sheet portion of the plank-cooking pan prevents the protected wooden plank from igniting and severely charring, although some minor scorching may be observed. Once the food item is sufficiently cooked, the plank-cooking pan can be removed from the heat source using a lifting tool as described above, leaving the charred sacrificial wooden plank behind (on the grill top). The plank-cooking pan can be used as a serving tray, or the protected wooden plank can be removed from the plank-cooking pan and the used as a serving platter. Alternatively, the food item can be removed from the protected wooden plank using tongs or other food handling devices.

It will be appreciated that a sacrificial wooden plank does not need to be covered by the plank-cooking pan. A sacrificial wooden plank can be positioned adjacent to the plank-cooking pan, or another smoke generating device or means could alternatively be used. However, it is critical that a protected wooden plank be placed on the top surface of the sheet portion of the plank-cooking pan.

Because the protected wooden plank is not substantially charred during cooking, it can be reused. However, it is preferably reused as a sacrificial wooden plank rather than a protected wooden plank. Furthermore, if the fluid tight package from which the protected wooden plank was removed is provided with a slideable resealing mechanism, the once-used protected wooden plank can be placed into the fluid tight package together with an amount of water and resealed for future use as a sacrificial wooden plank. Although the growth of mold is not likely, because the sacrificial wooden plank does not contact foods, it is of no consequence if some mold appears during extended storage.

One of the advantages provided by the use of a plank-cooking pan is that hydrating liquids such as liquor can be used to add distinctive flavoring to foods. Application of liquor to conventional wooden planks tends to encourage ignition and combustion of the cooking planks. Because the wooden planks used in combination with a plank-cooking pan are protected from direct exposure to the heat source, the risk of ignition is reduced, and the distinctive flavor provided by liquor and other alcohol and/or oil containing hydrating liquids can be transferred to food items.

Preferably, a plurality of wooden planks according to the invention are packaged together in one or more fluid tight packages and sold as a kit. The kit can further comprise a plank-cooking pan, a lifting tool and/or a package of spices for use in flavoring food to be grilled on the wooden plank. The kit can also comprise a cookbook that provides recipes and techniques for plank grilling food items.

The following examples are intended only to illustrate the invention and should not be construed as imposing limitations upon the claims.

### EXAMPLE 1

Sample 1A and Sample 1B were cut from the same piece of kiln-dried western redcedar. Each sample measured about 4½″×4½″×⅞″. Sample 1A weighed 120.5 grams and Sample 1B weighed 122.0 grams.

Sample 1A was placed in a stovetop pressure cooker filled with 1 quart of tap water. The pressure cooker was brought to a temperature of 250° F. and a pressure of about 15 psi above atmospheric pressure. The temperature and pressure were maintained for about 30 minutes. Sample 1A was permitted to cool to ambient temperature while soaking in the water and was then vacuum sealed in a fluid tight plastic bag using a FOODSAVER® 1200 model vacuum sealer.

Sample 1B was placed in a stockpot on two copper wires spaced about two inches apart. Two additional copper wires were placed on the top surface of Sample 1B and a drinking glass filled with water was set on the wires to pin Sample 1B to the bottom of the stockpot. The wires served to create a gap that would permit water to reach all surfaces of Sample 1B. Tap water was then poured into the stockpot until the top surface of Sample 1B was covered by three inches of water. Sample 1B was permitted to soak in the water at a depth of three inches for a period of twenty-four hours.

Sample 1A was removed from the vacuum-sealed plastic bag at the same time Sample 1B was removed from the stockpot of water. Sample 1A and Sample 1B were permitted to air dry for about 10 minutes on a baking rack (until no water sheen was visible on the samples) and then both samples were weighed. Sample 1A weighed 147 grams and Sample 1B weighed 140 grams. Sample HA thus absorbed 47.2% more tap water than did Sample 1B.

Samples 1A and 1B were placed side-by-side onto the same cooking zone of a cooking surface of an outdoor barbecue grill set to medium heat. Sample 1A appeared to produce more visible smoke for a longer period of time than did Sample 1B. Sample 1A also did not char or ignite as soon as Sample 1B.

### EXAMPLE 2

Six wooden planks measuring 5¾″×3½″×⅞″ were cut from the same piece of kiln-dried western redcedar and marked as Samples 2A through 2F, respectively. Each wooden plank was placed into a 1 quart ZIPLOC® freezer bag together with ⅓ cup of MOTT'S® unsweetened pasteurized apple juice from concentrate. The ZIPLOC® freezer bags were sealed and the wooden planks were manipulated until they were coated on all surfaces with apple juice. The planks were then placed in a freezer for twenty-four hours to freeze the apple juice.

The wooden planks to which the frozen apple juice adhered were removed from the ZIPLOC® freezer bags and individually vacuum-sealed in a fluid tight plastic bag using a FOODSAVER® 1200 model vacuum sealer. The fluid tight packages containing wooden planks and apple juice were allowed to warm to room temperature (about 70° F.) and were stored in a darkened closet without refrigeration. One of the six vacuum-sealed plastic bags was opened every week for six weeks and inspected for signs of spoilage and/or bacterial growth. Mold blooms were apparent in all six bags by the end of the first week. The mold blooms were easily rinsed off the wooden planks once the wooden planks were removed from the vacuum-sealed bags.

### EXAMPLE 3

Six wooden planks measuring 5¾″×3½″×⅞″ were cut from the same piece of kiln-dried western redcedar used to form the wooden planks used in Example 2 and marked as Sampled 3A through 3F, respectively. All six of the wooden planks were placed in a stovetop pressure cooker and covered with an amount of MOTT'S® unsweetened pasteurized apple juice from concentrate sufficient to cover the wooden planks when pressed to the bottom of the pressure cooker. The pressure cooker was brought to a temperature of 250° F. and a pressure of about 15 psi above atmospheric pressure. The temperature and pressure were maintained for about 15 minutes at which time the pressure was rapidly released and the wooden planks were turned over. The pressure cooker was resealed and brought to a temperature of 250° F. and a pressure of about 15 psi above atmospheric pressure for a second time. The temperature and pressure were maintained for another 15 minutes at which time the pressure cooker was permitted to cool to ambient temperature (about 70° F.). The wooden planks were removed from the apple juice and separately sealed in fluid tight plastic bags using a FOODSAVER® 1200 model vacuum sealer.

The fluid tight packages containing the wooden planks hydrated with apple juice were allowed to warm to room temperature (about 70° F.) and were stored in a darkened closet without refrigeration. One of the six vacuum-sealed plastic bags was opened every week for six weeks and inspected for signs of spoilage and/or bacterial growth. No bacteria or mold blooms were observed at any point during the six-week period.

### EXAMPLE 4

A plank of western redcedar measuring 5¾″×3½″×⅞″ was hydrated with apple juice and vacuum-sealed exactly as described in Example 3 above. The fluid tight package containing the hydrated wooden plank was marked as Sample 4A and was placed into a darkened closet.

Eleven months and 13 days after Sample 4A was placed into the darkened closet, a plank of western redcedar measuring 5¾″×3½″×⅞″ was submerged in apple juice at a depth of 3″ as described (with respect to tap water) in Example 1B. Twenty-four hours later, the wooden plank was removed from the apple juice and marked as Sample 4B. Sample 4A was then removed from its fluid tight package, and both Sample 4A and Sample 4B were cut in half using a power miter saw.

One half of Sample 4A and one half of Sample 4B were placed side-by-side onto the same cooking zone of a cooking surface of an outdoor barbecue grill set to medium heat. Samples 4A and 4B both began to generate visible amounts of smoke within five minutes of being placed over the burners of the outdoor barbecue grill. Sample 4B began to char sooner than Sample 4A. Sample 4B eventually ignited and burned before Sample 4B caught fire.

The other half of Sample 4A and the other half of Sample 4B were placed onto the top surface of separate plank-cooking pans (stainless steel) and then placed side-by-side onto the same cooking zone of a cooking surface of an outdoor barbecue grill set to medium heat. Neither Sample 4A nor Sample 4B appeared to generate much smoke, and neither charred or caught fire. After 45 minutes of exposure to the heat source, the samples were allowed to cool and were inspected. Sample 4B showed significantly more scorching on its bottom surface than did Sample 4A.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

1. A product comprising a fluid tight package within which has been sealed a wooden plank that has absorbed a hydrating liquid, the wooden plank having a top surface for contacting and supporting a food item while the food item is cooked over or adjacent to a heat source.

2. The product according to claim 1 wherein the wooden plank has absorbed an amount of a hydrating liquid that is greater than would have been absorbed by the wooden plank had the wooden plank been submerged in an open container of 70° F. water at atmospheric pressure for a period of twenty four hours at a depth of three inches as measured from the surface of the water to the top surface of the wooden plank.

3. The product according to claim 1 wherein the wooden plank is formed from a wood selected from the group consisting of western redcedar, alder, apple, cherry, hickory, pecan and mesquite.

4. The product according to claim 1 wherein a plurality of the wooden planks are sealed within the fluid tight package.

5. The product according to claim 1 wherein the fluid tight package is a vacuum-sealed container comprised of a polymeric film.

6. The product according to claim 1 wherein the hydrating liquid is selected from the group consisting of water, fruit juices and extracts, vegetable juices and extracts, beer, wine, liquor, vinegar and combinations thereof.

7. The product according to claim 1 wherein an amount of a chemical agent sufficient to inhibit the growth of bacteria and mold within the fluid tight package for at least 180 days without refrigeration is sealed within the fluid tight package.

8. The product according to claim 7 wherein the chemical agent is one or more selected from the group consisting of benzoic acid, sorbic acid and precursors thereof.

9. The product according to claim 1 wherein the wooden plank has a length dimension of from about 8 inches to about 18 inches, a width dimension of from about about 3 1/2 inches to about 10 inches, and a thickness dimension of from about ⅛ of an inch to about ⅜ of an inch.

10. In combination, a plank-cooking pan and a wooden plank, the plank-cooking pan comprising:
a sheet portion formed of a non-combustible material, the sheet portion having a top surface for supporting the wooden plank, and
a top wall portion extending upwardly from a perimeter edge of the sheet portion at least as high as a thickness dimension of the wooden plank.

11. The combination according to claim 10 wherein the plank-cooking pan further comprises a bottom wall portion extending downwardly from the perimeter of the sheet portion.

12. The combination according to claim 11 wherein a plurality of openings are provided in the bottom wall portion.

13. The combination according to claim 10 wherein the plank-cooking pan is formed of stainless steel.

14. The combination according to claim 10 wherein a lifting bracket is attached to an outer side of the top wall portion of the plank-cooking pan, and the combination further comprises a lifting tool having a handle portion and a hook portion, the hook portion being configured to slide upwardly into a space between the lifting bracket and the outer side of the top wall portion of the plank-cooking pan.

15. A method of cooking a food item comprising:
providing a fluid tight package within which has been sealed a wooden plank that has absorbed a hydrating liquid;
removing the wooden plank from the fluid tight package;
placing the food item in contact with a top surface of the wooden plank; and
allowing the wooden plank to support the food item over or adjacent to a heat source for a period of time sufficient to cook the food item.

16. The method according to claim 15 wherein the heat source is a selectively operable burner of an outdoor barbecue grill.

17. The method according to claim 15 further comprising, prior to the allowing step:
providing a plank-cooking pan comprising:
a sheet portion formed of a non-combustible material, the sheet portion having a top surface for supporting the wooden plank, and
a top wall portion extending upwardly from a perimeter edge of the sheet portion at least as high as a thickness dimension of the wooden plank;
placing the plank-cooking pan over or adjacent to the heat source; and
placing the wooden plank on the top surface of the sheet portion of the plank-cooking pan.

18. The method according to claim 17 wherein the plank-cooking pan further comprises a bottom wall portion extending downwardly from the perimeter of the sheet portion, a plurality of openings are provided in the bottom wall portion, and a sacrificial wooden plank is disposed under the plank-cooking pan for at least a portion of the time during which the food item is being cooked.

19. The method according to claim 17 wherein a lifting bracket is attached to an outer side of the top wall portion of the plank-cooking pan.

20. The method according to claim 19 further comprising:
lifting the plank-cooking pan from the heat source when the food is cooked using a lifting tool having a handle portion and a hook portion, the hook portion sliding upwardly into a space between the lifting bracket and the outer side of the top wall portion of the plank-cooking pan during lifting.
